(19) United States
(12) Patent Application Publication
(10) Pub. No.: US 2009/0020909 A1
(43) Pub. Date: Jan. 22, 2009

(54) Flat Die and Method for Manufacturing Laminated Resin Film or Sheet Using the Same

(75) Inventors: Kenichi Shirai, Hasuda (JP); Yuji Yamashita, Higashihiroshima (JP)

Correspondence Address: WENDEROTH, LIND & PONACK, L.L.P., 2033 K STREET N. W., SUITE 800, WASHINGTON, DC, 20006-1021, US

(73) Assignee: SEKISUI CHEMICAL CO., LTD., Osaka (JP)

(21) Appl. No.: 11/921,576

(22) PCT Filed: Jun. 28, 2006
(86) PCT No.: PCT/JP2006/312865

§ 371 Date: Dec. 5, 2007

(30) Foreign Application Priority Data
Jun. 29, 2005 (JP) 2005-190773
Aug. 10, 2005 (JP) 2005-232471

(51) Int. Cl. B29C 45/16

(52) U.S. Cl. 264/250; 425/130

(57) ABSTRACT

There is provided a flat die adapted to achieve a desired thickness distribution without a complicated structure even in laminating resins having different viscosities in molding.

A flat die 1 of the present invention includes a resin inlet portion 20, a manifold 21 connected to the resin inlet portion 20, and a lip opening 12. The flat die 1 further includes a projecting cavity 22, whereby, when resins of different kinds flow in the manifold 21 in a laminated condition in a thickness direction, each of the resins spreads in a different way in the width direction.

### BACKGROUND OF THE INVENTION

1. Field of the Invention

The present invention relates to a flat die, and simultaneously to a method for manufacturing a laminated resin film or sheet in which a plurality of resins are laminated, using the flat die.

2. Description of the Related Art

In molding a sheet, a flat die (or T-die) is used because a lip opening of a die is necessary to have an elongated shape. The die has a resin inlet portion and a manifold, which is wider than the resin inlet portion in a width direction and is connected to the resin inlet portion. Resin introduced through the resin inlet portion flows so as to spread out in the width direction within the manifold, whereupon the resin is discharged through the lip opening.

In molding a laminated sheet made of a plurality of resins, a coextrusion method, whereby all resins are laminated in molten state, is widely used.

In molding a laminated sheet by coextrusion, there are several kinds of methods such as a feed-block method and a multi-manifold method depending on timings of lamination of extruded resins.

By the feed-block method, a plurality of resins are laminated in the resin inlet portion to be introduced into the manifold, in which the laminated resins spread in a width direction maintaining its lamination. Then, the resins are discharged through the lip opening.

By the multi-manifold method, every resin requires a resin inlet portion and a manifold, in which the every resin spreads in a width direction. Then, the resins are laminated before the lip opening

There is another method, whereby every resin requires a resin inlet portion and a manifold, in which the every resin spreads in a width direction. Thereafter, the every resin is discharged, and then, the resins are laminated.

The feed-block method allows a structure of a flat die more simply than the other methods because of no need to dispose a manifold according to each resin to be laminated. However, in the case of lamination of resins having different flowability in molding, or of resins having different viscosities, for example, the resins have different flow characteristics in a width direction within the manifold. Thus, it is difficult to achieve an intended thickness distribution such as equalization of a thickness distribution of molded articles over its full width in a width direction.

In the case of resins having largely different viscosities, a lower viscosity resin might occupy edges of a molded article or slip into the back of a higher viscosity resin.

Further, edges of a molded laminated sheet in a width direction are often cut, a central part being used as a product and the edges being recycled. If a lower viscosity resin is a sticky resin, such as an adhesive sheet, it has few advantages in recovering and recycling the resin, whereas a higher viscosity resin has a great advantage in recovering and recycling the resin. Therefore, a lower proportion of a lower viscosity resin is more preferable.

If a molded article contains a large quantity of lower viscosity resin adjacent to its edges, a material recycled from the cut edges contains a greater proportion of lower viscosity material, resulting in difficulty in recycling of a higher viscosity material.

As a result, when resins having quite different viscosities are laminated, a technique to achieve the uniformity in thickness distribution is disclosed in the patent documents 1 and 2.

A method disclosed in the patent document 1 is designed to laminate resins at a resin inlet portion in such a manner as arranging more materials of higher viscosities and of lower fluidities toward outside in a width direction and more materials of lower viscosities toward inside in the width direction. When the resins spread in the width direction in a manifold, the higher viscosity resin is easier to spread in the width direction than the lower viscosity resin, so that a thickness distribution is uniformed.

A method disclosed in the patent document 2 is designed to dispose a protruding portion at upstream (adjacent to a resin inlet portion) of a manifold, to laminate a lower viscosity resin adjacent to the protruding portion, and to introduce resins from the resin inlet portion to the manifold. That controls flow distribution in the manifold, thereby achieving the uniformity in thickness distribution.

Patent Document 1: JP 2000-289085A

Patent Document 2: JP 2003-94506 A

### SUMMARY OF THE INVENTION

### Problems to be Solved by the Invention

The above-mentioned method disclosed in the patent document 1 has a limit to laminate resins at the resin inlet portion so as to arrange more materials of higher viscosities and of lower fluidities toward outside in the width direction and more materials of lower viscosities toward inside in the width direction. Thus, a big difference of viscosities might cause failure of the uniformity in thickness distribution or result in containing a large quantity of lower viscosity resin adjacent to the edges.

Further, the method disclosed in the patent document 2 also has a limit to increase a thickness of the protruding portion, and a big difference of viscosities might cause failure of the uniformity in thickness distribution or result in containing a large quantity of lower viscosity resin adjacent to the edges. That would make it difficult to recycle a high viscosity material.

Though another method such as a multi-manifold method is conventionally used for molding in the case that a feed-block method has a difficulty in molding resins into a desired thickness distribution, such a method complicates a structure of a device such as a die, as described above.

An object of the present invention is therefore to provide a flat die adapted to achieve a desired thickness distribution even in laminating resins having different viscosities in molding.

Herein, in the present invention, a term “flat die” collectively means a coat hanger die, a fishtail die, and a straight manifold die.

### Means to Solve the Problem

An aspect of the present invention to solve the above-mentioned problems and drawbacks is a flat die for use in molding at least two resins, including a resin inlet portion for introducing molten resins therethrough, a manifold connected to the resin inlet portion, and a lip opening for discharging the resins therethrough, wherein the manifold includes a cavity defining a width direction, a thickness direction, and a resin flowing direction, the directions being perpendicular to one another, wherein the manifold has a larger width in the width direction as compared with the resin inlet portion, wherein molten resins supplied to the die through the resin inlet portion are to enter the manifold and to flow so as to spread in the width direction in the manifold, then being discharged through the lip opening, and wherein, when resins of different kinds flow in the manifold in a laminated condition in which each resin forms a layer in the thickness direction, the die allows each resin to be introduced into the manifold so that one layer of resin spreads in the width direction in a different way from an adjoining layer of resin.

By the flat die, each resin is introduced into a manifold through a resin inlet portion so that one resin spreads in the width direction in a different way from another resin when resins of different kinds flow in the manifold in a laminated condition in the thickness direction. That facilitates adjustment of a thickness in manufacturing a laminated resin film and/or sheet composed of laminated resins having different viscosities.

Herein, the resins of different kinds laminated in the thickness direction may include not only two kinds of resins, but also more than two kinds of resins.

Another aspect of the present invention to solve the above-mentioned problems and drawbacks is a flat die for use in molding resin, including a resin inlet portion for introducing at least one molten resin therethrough, a manifold connected to the resin inlet portion and defining a width direction and a thickness direction perpendicular to the width direction, a projecting cavity formed adjacent to the resin inlet portion and to part of the manifold where the manifold is connected to the resin inlet portion so that the projecting cavity projects in the thickness direction as compared with the manifold, and a lip opening for discharging the resin therethrough, wherein the manifold has a larger width in the width direction as compared with the resin inlet portion, and wherein molten resin supplied to the die through the resin inlet portion and the projecting cavity is to enter the manifold and to flow so as to spread in the width direction in the manifold, then being discharged through the lip opening.

The flat die has a projecting cavity projecting in the thickness direction and formed adjacent to the resin inlet portion and to part of the manifold where the manifold is connected to the resin inlet portion, thereby restricting a molten resin proximal to the projecting cavity from spreading in the width direction, so as to obtain a desired thickness distribution.

In the flat die described above, the projecting cavity may include a first part adjacent to the manifold and a second part adjacent to the resin inlet portion, the first part having a larger width in the width direction than that of the second part. Such an arrangement facilitates stable flowing of the resin from the projecting cavity to the manifold.

The projecting cavity may have an inclined face adjacent to a distal end thereof, the face being located proximal to the lip opening and tapering toward the lip opening. Such an arrangement allows smooth flowing of the resin from the projecting cavity to the manifold.

It is possible to let the projecting cavity show a projection view in the thickness direction with no angle formed proximal to the lip opening. That avoids nonuniform flowing of the resin from the projecting cavity to the manifold and easily achieves the uniformity in thickness in the width direction

A method for manufacturing a laminated resin film and/or sheet using the flat die described above includes the steps of laminating a plurality of molten resins in the thickness direction, the resins including a lower viscosity resin and a higher viscosity resin, the lower viscosity resin having a lower viscosity at a molding temperature than that of the higher viscosity resin, introducing the resins through the resin inlet portion and the projecting cavity into the manifold, and discharging through the lip opening the resins having passed through the manifold, so that the lower viscosity resin is molded so as to be located proximal to the projecting cavity. The method performs molding with restricting the lower viscosity resin from spreading in the width direction.

Still another aspect of the present invention is a flat die for use in molding resin, including a resin inlet portion for introducing at least one molten resin therethrough, a manifold connected to the resin inlet portion, and a lip opening for discharging the resin therethrough, wherein the manifold includes a cavity defining a width direction, a thickness direction, and a resin flowing direction, the directions being perpendicular to one another, wherein the manifold has a larger width in the width direction as compared with the resin inlet portion, and wherein molten resin supplied to the die through the resin inlet portion is to flow into the manifold in a manifold-inflow direction crosswise to the resin flowing direction, so that the supplied resin enters the manifold and flows so as to spread in the width direction in the manifold, then being discharged through the lip opening.

Herein, the resin inlet portion may be of any shape only if the portion has a manifold-inflow direction crosswise to the resin flowing direction. For example, a path to the manifold from the resin inlet, through which molten resin is introduced, of the resin inlet portion may be of a linear shape or of a partially or entirely curved or bent shape. Further, a cross sectional shape of the resin inlet portion in a plane perpendicular to the manifold-inflow direction may have the same shape over its full length or may be different by location.

By the flat die, a manifold-inflow direction is crosswise to the resin flowing direction, so that a resin having been introduced through the resin inlet portion in a laminated condition and positioned in the outer side spreads in the width direction easier than a resin positioned in the inner side. Thereby, a desired thickness distribution is obtained.

In the flat die described above, the resin inlet portion may be a columnar cavity having a longitudinal direction substantially identical with the manifold-inflow direction. Such an arrangement facilitates manufacturing of a flat die and fixing of a manifold-inflow direction line.

Further, the resin inlet portion may have a substantially same cross sectional shape in any plane perpendicular to the manifold-inflow direction over its full length in the manifold-inflow direction. Such an arrangement avoids flow disturbance when molten resins flow in a laminated condition, thereby stabilizing a thickness distribution of molded articles in molding a laminated resin film/sheet.

Herein, the resin inlet portion may have not entirely the identical cross sectional shape in some part, may have small indents formed thereon, or may vary in size in some degree.

A method for manufacturing a laminated resin film and/or sheet using the above-mentioned flat die, including the steps of laminating a plurality of resins in the width direction so that a resin of a low viscosity at a molding temperature is located proximal to the lip opening, introducing the resins through the resin inlet portion, and molding the resins. The method performs molding with restricting the lower viscosity resin from spreading in the width direction.

Still another aspect of the present invention is a flat die for use in molding at least two molten resins, including a plurality of resin inlet portions for introducing molten resins therethrough, a manifold connected to the resin inlet portions, and a lip opening for discharging the resins therethrough, wherein the manifold includes a cavity defining a width direction, a thickness direction, and a resin flowing direction, the directions being perpendicular to one another, wherein the manifold has a larger width in the width direction as compared with the resin inlet portions, and wherein the resin inlet portions are connected to the manifold at an identical position in the width direction and at different positions in the resin flowing direction, so that molten resins supplied to the die through the resin inlet portions enter the manifold and flow so as to spread in the manifold in the width direction, then being discharged through the lip opening.

By the flat die, a plurality of the resin inlet portions are connected to the manifold at an identical position in the width direction and at different positions in the resin flowing direction, so as to change degree of spreading in the width direction of the molten resin being introduced through each resin inlet portion. That enables a thickness distribution as intended.

A method for manufacturing a laminated resin film and/or sheet using the above-mentioned flat die includes the steps of introducing different resins into the resin inlet portions respectively, and molding the resins, wherein a molten resin of a low viscosity at a molding temperature is introduced through a resin inlet portion connected to the manifold proximal to the lip opening. The method performs molding with restricting the lower viscosity resin from spreading in the width direction.

In the method for manufacturing a laminated resin film and/or sheet, the laminated resin film and/or sheet just after being discharged through the lip opening shows a lower proportion of the lower viscosity resin to all the resins at each part adjacent to both edges than that at the other part or has no lower viscosity resin adjacent to the both edges. Thereby, edges of resin after molding is cut and conveniently recycled because the edges contain a higher proportion of a higher viscosity resin.

A zero shear viscosity is used so as to compare viscosities at a molding temperature.

### Advantageous Effect of the Invention

The flat die of the present invention can use a feed-block method so as to mold a sheet in which resins having widely different viscosities in molding are laminated. In particular, even in laminating resins having quite different viscosities, a desired thickness distribution is obtained.

### BRIEF DESCRIPTION OF THE DRAWINGS

FIG. 1 is a perspective view showing an inner cavity of a flat die of a first embodiment of the present invention;

FIG. 2 is an enlarged perspective view of a vicinity of a projecting cavity of the flat die shown in FIG. 1;

FIGS. 3A to 3F are cross sections of resins of a low viscosity and a high viscosity within the flat die, FIG. 3A being a cross section taken along a line A-A, FIG. 3B being a cross section taken along a line B-B, FIG. 3C being a cross section taken along a line C-C, FIG. 3D being a cross section taken along a line D-D, FIG. 3E being a cross section taken along a line E-E, and FIG. 3F being an enlarged cross section of a vicinity of an edge of FIG. 3E;

FIG. 4 is a perspective view showing part of an inner cavity of a flat die of a second embodiment of the present invention;

FIG. 5 is a perspective view showing part of an inner cavity of a flat die of a third embodiment of the present invention;

FIGS. 6A and 6B are views each showing part of the inner cavity of the flat die in FIG. 5, FIG. 6A being a front elevation thereof, and FIG. 6B being a side elevation thereof;

FIG. 7 is a perspective view showing part of an inner cavity of a modified embodiment of the flat die of the present invention;

FIG. 8 is a perspective view showing part of an inner cavity of a further modified embodiment of the flat die of the present invention;

FIG. 9 is a perspective view showing part of an inner cavity of a further modified embodiment of the flat die of the present invention;

FIG. 10 is a perspective view showing part of an inner cavity of a further modified embodiment of the flat die of the present invention;

FIG. 11 is a perspective view showing part of an inner cavity of a further modified embodiment of the flat die of the present invention;

FIG. 12 is a perspective view showing part of an inner cavity of a further modified embodiment of the flat die of the present invention;

FIG. 13 is a perspective view showing part of an inner cavity of a further modified embodiment of the flat die of the present invention;

FIG. 14 is a perspective view showing part of an inner cavity of a further modified embodiment of the flat die of the present invention;

FIG. 15 is a perspective view showing part of an inner cavity of a further modified embodiment of the flat die of the present invention;

FIG. 16 is a perspective view showing part of an inner cavity of a further modified embodiment of the flat die of the present invention;

FIG. 17 is a perspective view showing part of an inner cavity of a further modified embodiment of the flat die of the present invention;

FIG. 18 is a perspective view showing part of an inner cavity of a further modified embodiment of the flat die of the present invention;

FIG. 19 is a perspective view showing part of an inner cavity of a further modified embodiment of the flat die of the present invention;

FIG. 20 is a perspective view showing part of an inner cavity of a further modified embodiment of the flat die of the present invention;

FIG. 21 is a perspective view showing part of an inner cavity of a further modified embodiment of the flat die of the present invention;

FIG. 22 is a perspective view showing part of an inner cavity of a further modified embodiment of the flat die of the present invention;

FIG. 23 is a perspective view showing part of an inner cavity of a further modified embodiment of the flat die of the present invention;

FIG. 24 is a perspective view showing part of an inner cavity of a flat die of a fourth embodiment of the present invention;

FIGS. 25A and 25B are views of the flat die in FIG. 24, FIG. 25A being an enlarged perspective view of a vicinity of a resin inlet portion, and FIG. 25B being a cross section taken along a line E-E in FIG. 25A;

FIGS. 26A to 26E are cross sections of resins of a low viscosity and a high viscosity within the flat die, FIG. 26A being a cross section taken along a line A-A, FIG. 26B being a cross section taken along a line B-B, FIG. 26C being a cross section taken along a line C-C, FIG. 26D being a cross section taken along a line D-D, and FIG. 26E being an enlarged cross section of a vicinity of an edge of FIG. 26D;

FIG. 27 is a perspective view showing an inner cavity of a modified embodiment of the flat die of the fourth embodiment of the present invention;

FIGS. 28A and 28B are views of the flat die shown in FIG. 27, FIG. 28A being an enlarged perspective view of a vicinity of a resin inlet portion, and FIG. 28b being a cross section taken along a line F-F in FIG. 27;

FIG. 29 is a perspective view showing an inner cavity of a flat die in a fifth embodiment of the present invention;

FIGS. 30A and 30B are views of the flat die shown in FIG. 29, FIG. 30A being an enlarged perspective view of a vicinity of a resin inlet portion, and FIG. 30B being a cross section taken along a line G-G in FIG. 28;

FIG. 31 is a perspective view showing a modified embodiment of the flat die of the fifth embodiment of the present invention;

FIG. 32 is a graph showing a thickness distribution of a lower viscosity resin in the example 4; and

FIG. 33 is a graph showing a thickness distribution of a lower viscosity resin in the comparative example 4.

### DESCRIPTION OF THE NUMERALS

1, 1a, 2, 3, 4, 5, 6, 7, 8, 9: flat die
51, 52, 53, 54, 55, 56, 57, 58, 59, 60: flat die
101, 101a, 102, 102a: flat die
20, 50: resin inlet portion
21: manifold
22: projecting cavity
90a: lower viscosity resin
90b: higher viscosity resin
91: laminated sheet
N: longitudinal direction
T: thickness direction
S: resin flowing direction
W: width direction

### DESCRIPTION OF THE PREFERRED EMBODIMENT

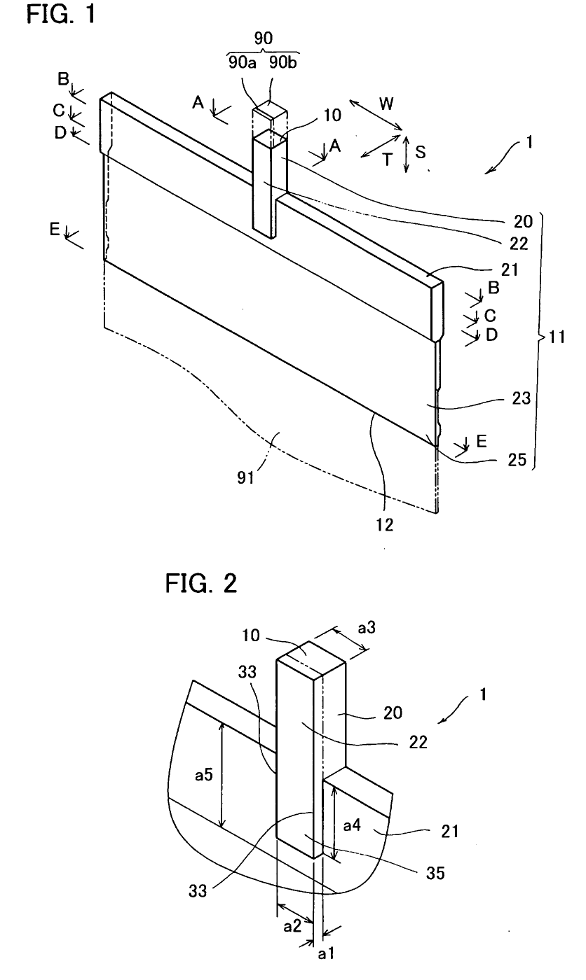

An inner structure of a flat die 1 of a first embodiment of the present invention is shown in FIG. 1. The flat die 1 includes a resin inlet 10, an inner cavity 11, and a lip opening 12.

Herein, though not shown, the flat die 1 of the present invention is accompanied with at least two molds and used with these molds, similarly to a normal one.

The resin inlet 10 is connected to a feed block not shown, in which molten resins 90 are laminated. The laminated molten resins 90 are poured into the resin inlet 10, passed through the inner cavity 11, and extruded to be discharged through the lip opening 12 as a laminated sheet 91.

The inner cavity 11 is symmetric and includes a resin inlet portion 20, a manifold 21, a projecting cavity 22, a pre-land section 23, and a lip land 25, all parts each having a width in a width direction “W”, a thickness in a thickness direction (a direction perpendicular to the width direction “W”) “T”, and a length in a resin flowing direction (a direction perpendicular to the width direction “W” and the thickness direction “T”) “S”.

The resin inlet portion 20 is a rectangular prism cavity having a proximal end arranged with the resin inlet 10 and a distal end connected to the manifold 21. The resin inlet portion 20 is connected to the manifold 21 in the substantially center of the width direction “W”.

The manifold 21 is a cavity having a larger width than that of the resin inlet portion 20. The width of the manifold 21 is substantially the same as those of the lip land 25 and the lip opening 12.

As shown in FIG. 1, the projecting cavity 22 is formed adjacent to the resin inlet portion 20 and to a part of the manifold 21 where the manifold 21 is connected to the resin inlet portion 20. The projecting cavity 22 is a cavity projecting in the thickness direction “T” and including a first part adjacent to the manifold 21 and a second part adjacent to the resin inlet portion 20, being disposed at only one side in the flat die 1 of the present embodiment.

Therefore, a part where the projecting cavity 22 is disposed has a larger thickness than those of other parts of the inner cavity 11, so that the manifold 21 only has a larger thickness at an upper part adjacent to its center.

The projecting cavity 22 of the present embodiment shows a projection view of a rectangular shape in the thickness direction “T” and has an equal thickness over its full length. Further, the projecting cavity 22 has the same width as that of the resin inlet portion 20. Further, the projecting cavity 22 has a larger length than that of the resin inlet portion 20 and a shorter length than a total length of the resin inlet portion 20 and the manifold 21.

Herein, in the case that the width of the first part of the projecting cavity 22 is smaller than that of the resin inlet portion 20, the resins 90 become difficult to flow toward the first part of the projecting cavity 22. Thus, the width of the first part is preferably larger than that of the resin inlet portion 20. On the other hand, in the case that the width of the first part of the projecting cavity 22 is too much larger than that of the resin inlet portion 20, a lower viscosity resin 90a described below flows in the width direction “W” in the projecting cavity 22, resulting in difficulty to restrict the lower viscosity resin 90a from flowing in the width direction “W”. Thus, the width of the first part of the projecting cavity 22 is preferably 50% or less of a total width of the manifold 21, more preferably 20% or less, and most preferably 10% or less.

Further, the length of the first part of the projecting cavity 22 is smaller than that of the manifold 21.

The projecting cavity 22 preferably has a shape as described below.

Referring to FIG. 2, a thickness “a1” of the projecting cavity 22 is between 0.5 mm and 20 mm, and more preferably between 1 mm and 10 mm. A width “a2” thereof is the same as a width “a3” of the resin inlet 10 or more but no more than the width “a3” plus 20 mm. A length “a4” of a lower part (viz. the first part) 35 of the projecting cavity 22 is no more than a length “a5” of the manifold 21.

The projection view of the projecting cavity 22 in the thickness direction “T” can be of a shape other than a rectangular shape by changing the width “a2” and the length “a4” according to location. Further, the thickness “a1” of the projecting cavity 22 can be changed according to location.

It is possible to form sides 33 of the projecting cavity 22 into a rounded shape or into an inclined shape, for example, so as to improve flowing of the resins 90. In order to form an inclined face, the width of the projecting cavity 22 preferably tapers downward.

The molten resins 90 flow in the inner cavity 11 and basically proceed in the resin flowing direction “S”. The resin inlet portion 20 is directed in the resin flowing direction “S”.

The molten resins 90 are introduced through the resin inlet portion 20 and the projecting cavity 22 into the manifold 21.

In the manifold 21, the molten resins 90 having introduced through the resin inlet 10 spread in the width direction “W”, so as to have a flowing direction containing a transverse component in the width direction “W”.

The molten resins 90 having passed through the manifold 21 pass through the pre-land section 23 and the lip land 25, thereafter being extruded and discharged through the lip opening 12.

The pre-land section 23 is a region that restricts passage of the resins 90 therethrough more than other parts, thereby adjusting pressure distribution in the width direction “W” so as to stabilize flowing of the molten resins 90 after the pre-land section 23.

Next, a method for molding a laminated sheet 91 using the flat die 1 of the first embodiment of the present invention will be described in detail below.

The molten resins 90 in a laminated condition are introduced from a feed block not shown through the resin inlet 10 into the inner cavity 11. At this time, as shown in FIG. 1, the molten resins 90 are composed of a lower viscosity resin 90a and a higher viscosity resin 90b in a laminated condition. The molten resins 90 are laminated in the thickness direction “T” so that the lower viscosity resin 90a comes adjacent to the projecting cavity 22.

The lower viscosity resin 90a has a lower viscosity at a molding temperature as compared with the higher viscosity resin 90b. This comparison can be performed by a zero shear viscosity.

Generally, resin is non-Newtonian liquid and its viscosity coefficient changes according to a shear speed. A zero shear viscosity is a viscosity coefficient at a shear speed of zero (1/s) envisioned from a viscosity coefficient around a low shear speed. Normally, as to resin, a viscosity coefficient is substantially constant at a low shear speed (0.1 (1/s) or less). Thus, a viscosity is confirmed by measuring a viscosity coefficient at such a low shear speed.

Resins used for the flat die 1 of the present invention can be any kind and as follows, for example.

The resins include thermoplastic resins such as an ultralow density polyethylene, a low-density polyethylene, a linear low-density polyethylene, a medium-density polyethylene, a high-density polyethylene, an ethylene-polyvinyl chloride copolymer, a polyvinyl alcohol, an ethylene-vinyl acetate copolymer, an ethylene-ethyl acrylate copolymer, a polyvinyl acetate, a polypropylene, a polybutene, a polycarbonate, a polybutylene terephthalate, a polyethylene terephthalate, a polystyrene, a maleimide polymer, a polysulfone, a polyethersulfone, a polyvinylidene-fluoride, a poly(meta)acrylate, a cellulose ester, and a polynorbornene. Herein, to the above-mentioned thermoplastic resins, an additive such as a plasticizer and an ultraviolet absorber may be added.

Then, the molten resins 90 having been introduced through the resin inlet 10 in a laminated condition pass through the resin inlet portion 20 and the projecting cavity 22, entering the manifold 21.

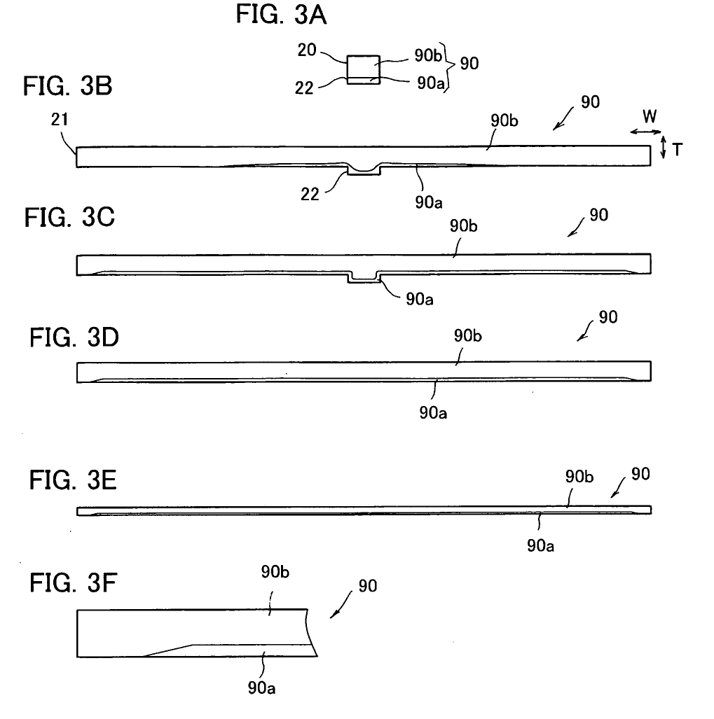

FIG. 3A shows a condition of the molten resins 90 adjacent to the resin inlet portion 20, in the same laminated condition as being introduced through the resin inlet 10.

The molten resins 90 flow further toward the manifold 21. Upon entering the manifold 21, the molten resins 90 flow in an entire area of the width direction “W”. As shown in FIG. 3B, the lower viscosity resin 90a mainly flows in the projecting cavity 22 and is difficult to flow in the width direction “W” as compared with the higher viscosity resin 90b, so that a thickness distribution of the lower viscosity resins 90a is adjusted.

Specifically, when the lower viscosity resin 90a mainly flowing in the projecting cavity 22 is about to head in the width direction “W”, the thickness of the thickness direction “T” becomes narrower, thereby making the resin 90a harder to flow. That allows adjustment of flowing of the lower viscosity resin 90a that is relatively flowable. Further, according to need, a shape of the projecting cavity 22 can be changed so as to make an easy-to-flow part and a difficult-to-flow part from the projecting cavity 22 to the manifold 21. That adjusts flowing of the lower viscosity resin 90a in the width direction “W”, thereby obtaining a desired thickness distribution.

As the molten resins 90 proceed in the resin flowing direction “S” within the manifold 21, as shown in FIG. 3C, the lower viscosity resin 90a gradually flows in the width direction “W” because the lower viscosity resin 90a is more flowable than the higher viscosity resin 90b. Then, the molten resins 90 proceed close to the end of the manifold 21 adjacent to the pre-land section 23 (exit of the manifold 21). In this state, as shown in FIG. 3D, the lower viscosity resin 90a does not exist in the entire area of the manifold 21 in the width direction “W” and has both edges in the width direction “W” positioned at inner sides of both sides of the width direction “W” of the manifold 21. The thickness of the lower viscosity resin 90a is substantially uniform except its both edges. The rest part is occupied by the higher viscosity resin 90b.

The molten resins 90 having passed through the manifold 21 flow through the pre-land section 23 and the lip land 25, then being extruded through the lip opening 12. During this flowing, the molten resins 90 do not flow in the width direction “W”, so as to flow maintaining a thickness ratio of the lower and the higher viscosity resins 90a and 90b, becoming into a state as shown in FIGS. 3E and 3F.

As shown in FIG. 3F, the molten resins 90 just after having been discharged through the lip opening 12 show a lower proportion of the lower viscosity resin 90a to all the resins at each part adjacent to the both edges than that at the other part.

Further, the both edges of the lower viscosity resin 90a in the width direction “W” are inside both edges of the higher viscosity resin 90b in the width direction “W”. The thickness of the lower viscosity resin 90a is substantially uniform except parts adjacent to the both edges.

A method for rolling up the laminated sheet 91 is not specifically limited and includes, for example, a method using a chill roll to draw and cool the laminated sheet 91 having been discharged through the lip opening 12, a method of pressing resin against a chill roll using an air knife, a touch roll, or electrostatic pinning, and a method of immersing the sheet 91 in a water tank to cool it. In any method, a method by which a proportion of layers is maintained in a condition produced from the flat die 1 can be employed.

In this way, the flat die 1 of the present embodiment is used for laminating resins so that the lower viscosity resin 90a comes to the projecting cavity 22, for supplying the molten resins 90 through the resin inlet 10, and for molding, thereby molding the laminated sheet 91 in such a way that a thickness distribution of the lower viscosity resin 90a in the thickness direction “T” becomes as intended.

The thickness distribution of the lower viscosity resin 90a in the laminated sheet 91 depends on conditions such as viscosities of the lower and the higher viscosity resins 90a and 90b, a thickness ratio between the lower and the higher viscosity resins 90a and 90b, and a shape of the projecting cavity 22 including the width in the width direction “W”, the thickness in the thickness direction “T”, the length in the resin flowing direction “S”, and the projection view thereof in the thickness direction “T”. Thus, the thickness distribution is modified as desired by changing the shape of the projecting cavity 22.

For example, in the case that the difference of viscosities of the lower and the higher viscosity resins 90a and 90b to be used is small, the thickness “a1” of the projecting cavity 22 should be made small (about 0.1 mm to 5 mm), whereas in the case that the difference is large, the thickness “a1” should be made large.

In order to change the shape of the projecting cavity 22, another die can be manufactured and used, but it is possible to dispose a detachable jig at a part corresponding to a position of the projecting cavity 22 so as to change the shape by attaching or detaching such a jig according to need.

The laminated sheet 91 is cooled, and molding is completed. However, according to need, both edges can be cut so that a part of a uniform thickness of the lower and the higher viscosity resins 90a and 90b remains. The cut edges are made of resin containing a high proportion of the higher viscosity resin 90b with quite low proportion of the lower viscosity resin 90a, so that the cut resin is easily recycled as a higher viscosity resin 90b.

As compared with the flat die 1 of the first embodiment, other embodiments each having a modified projecting cavity 22 will be described below, thereby molding a laminated sheet 91. A configuration or a shape other than a projecting cavity 22 is the same as that of the flat die 1, unless otherwise stated.

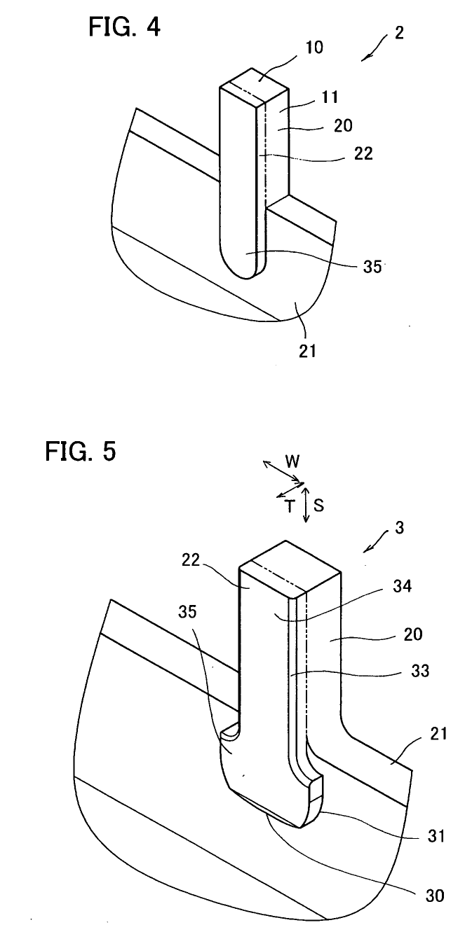

A flat die 2 of a second embodiment of the present invention is shown in FIG. 4. In the flat die 2, unlike the flat die 1, a projecting cavity 22 has a lower portion 35 of a semicircular shape at a lower part (the other side of the resin inlet 10) thereof with a curved edge and having a diameter substantially equal to the width of the resin inlet portion 20. The projecting cavity 22 has a U-shaped edge all around and the same configuration in the other part as in the flat die 1.

Therefore, the flat die 2 shows a projection view of the projecting cavity 22 in the thickness direction “T” with no angle formed proximal to the lip opening 12 (at the lower part of the projecting cavity 22). With an angle formed at the first part (adjacent to the manifold 21) of the projecting cavity 22, the lower viscosity resin 90a is more likely to flow toward the manifold 21 via the angle than via the other part, resulting in easy formation of a locally thick part of the lower viscosity resin 90a. However, the flat die 2 avoids such a formation and serves to achieve the uniformity in thickness.

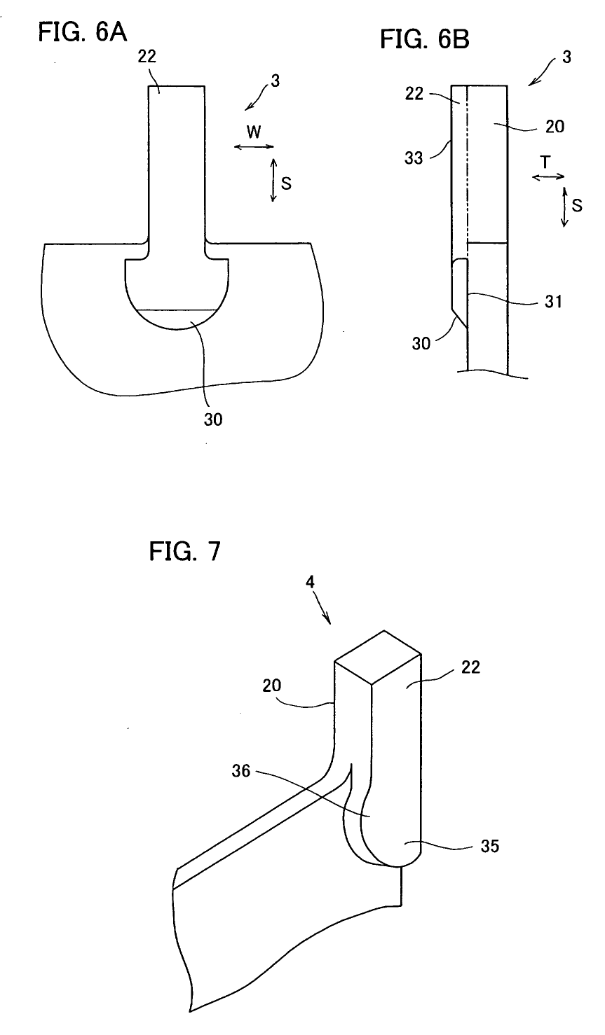

A flat die 3 in a third embodiment of the present invention is shown in FIGS. 5 and 6. In the flat die 3, a projecting cavity 22 has the same shape at an upper part as in the above-mentioned embodiments, but has a lower portion 35 of a semicircular shape at a lower part thereof with a curved edge and having a diameter larger than the width of the resin inlet portion 20. The lower portion 35 is located at the first part (adjacent to the manifold 21) of the projecting cavity 22 and has a width larger than that of an upper portion 34 formed at the second part (adjacent to the resin inlet portion 20) thereof.

Similarly to the flat die 2, the flat die 3 also shows a projection view of the projecting cavity 22 in the thickness direction “T” with no angle formed proximal to the lip opening 12.

Further, the projecting cavity 22 has an inclined face 30, in which the thickness tapers toward the lip opening 12, at the bottom of the lower portion 35.

The projecting cavity 22 has curved (rounded) sides 33 extending in the resin flowing direction “S” at both sides thereof in the thickness direction “T”.

Being used to mold, similarly to the flat die 2, the flat die 3 avoids easy formation of a locally thick part of the lower viscosity resin 90a. Further, it is possible to make the width of the lower part 35 of the projecting cavity 22 larger, so as to make a length of an edge 31 of the projecting cavity 22 connected to the manifold 21 in the thickness direction “T” larger. That facilitates a stable flow of the lower viscosity resin 90a when the resin 90a flows through the lower portion 35 of the projecting cavity 22 into the manifold 21.

Further, embodiments as shown in FIGS. 7 to 23 can be used. Herein, FIGS. 7 to 23 each show only half of a symmetric shape and the other half is omitted in the figure. Further, a configuration or a shape other than a projecting cavity 22 is the same as that of the flat die 1, unless otherwise stated.

In a flat die 4 shown in FIG. 7, a projecting cavity 22 has a lower portion 35 of a nearly circular shape and having a diameter slightly larger than the width of the resin inlet portion 20.

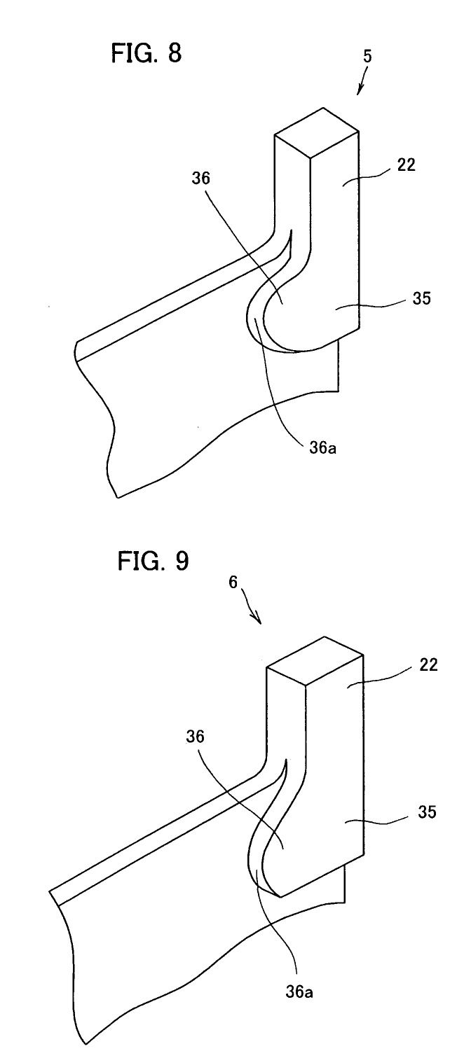

A flat die 5 shown in FIG. 8 has a projecting cavity 22, like that of the flat die 1 shown in FIGS. 1 and 2, with a protruding portion 36 protruding so as to extend in the width direction “W”. The protruding portion 36 has a curved edge all around with no angle formed.

A flat die 6 shown in FIG. 9 has, similarly to the flat die 5 shown in FIG. 8, a projecting cavity 22 with a protruding portion 36, but a top 36a of the protruding portion 36 is located at a lower side (proximal to the lip opening 12) of a top 36a of the protruding portion 36 of the flat die 5.

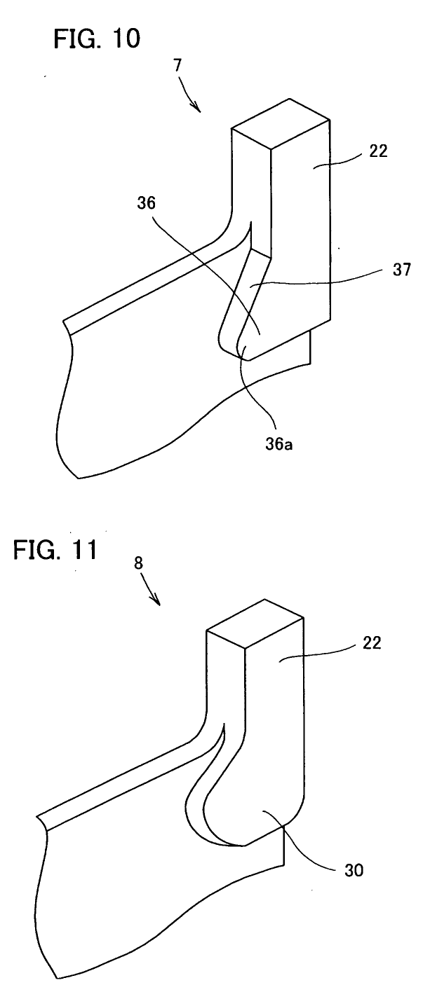

A flat die 7 shown in FIG. 10 has a projecting cavity 22, like that of the flat die 1 shown in FIGS. 1 and 2, with a protruding portion 36. The protruding portion 36 protrudes so as to extend in the width direction “W”. The protruding portion 36 has a curved edge adjacent to a top 36a with an inclined portion 37 formed at another part of the edge except the top 36a. The inclined portion 37 is located at an upper side (proximal to the resin inlet 10) of the top 36a.

A flat die 8 shown in FIG. 11 has a projecting cavity 22, like that of the flat die 5 shown in FIG. 8, with an inclined face 30 formed adjacent to the bottom thereof.

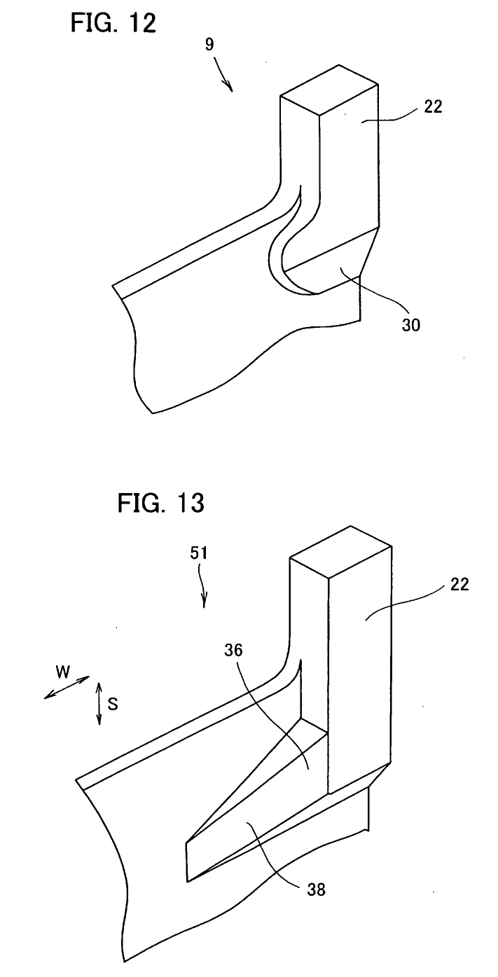

A flat die 9 shown in FIG. 12 has a projecting cavity 22, like that of the flat die 5 shown in FIG. 7, with an inclined face 30 formed adjacent to the bottom thereof.

A flat die 51 shown in FIG. 13 has a projecting cavity 22, like that of the flat die 1 shown in FIGS. 1 and 2, with a protruding portion 36. The protruding portion 36 protrudes so as to extend in the width direction “W” from a vicinity of the bottom of the projecting cavity 22 with an inclined portion 38, whose length and thickness tapers toward the side in the width direction “W”.

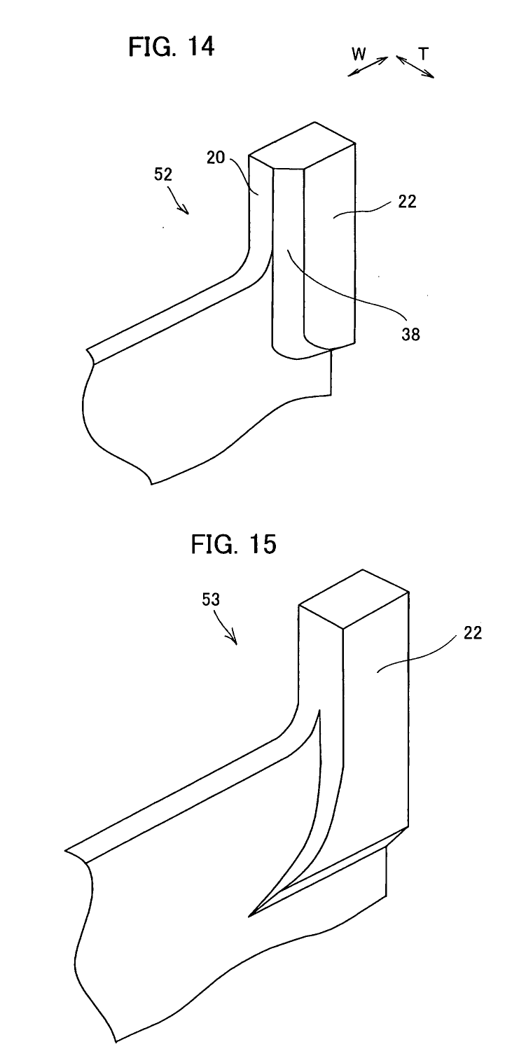

A flat die 52 shown in FIG. 14 has a projecting cavity 22, like that of the flat die 2 shown in FIG. 4, with an inclined portion 38. The projecting cavity 22 of the flat die 52 has the width tapering toward outside of the is thickness direction “T”.

A flat die 53 shown in FIG. 15 has a projecting cavity 22 extending in the width direction “W” toward its bottom.

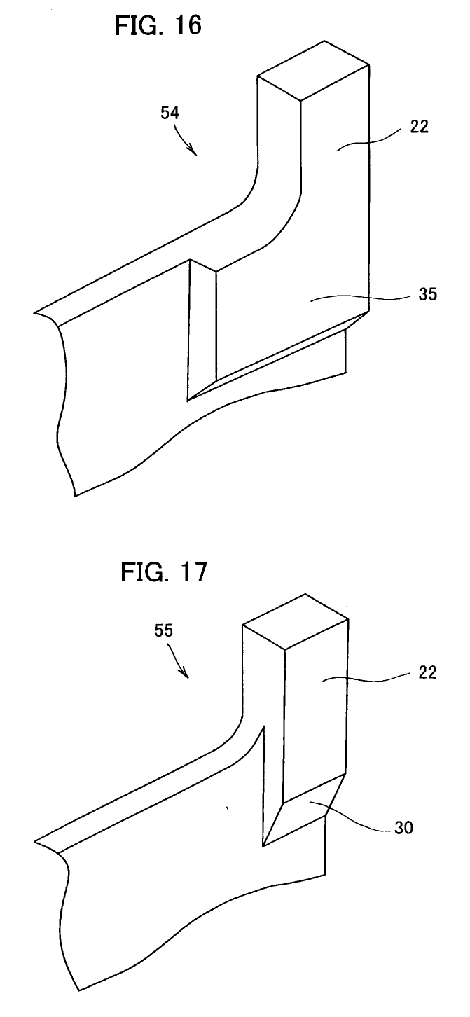

A flat die 54 shown in FIG. 16 has a projecting cavity 22 with a lower portion 35, which is wide in the entire area. The lower portion 35 shows a projection view of a rectangular shape in the thickness direction “T”.

A flat die 55 shown in FIG. 17 has a projecting cavity 22, like that of the flat die 1 shown in FIGS. 1 and 2, with an inclined face 30 formed at the bottom thereof.

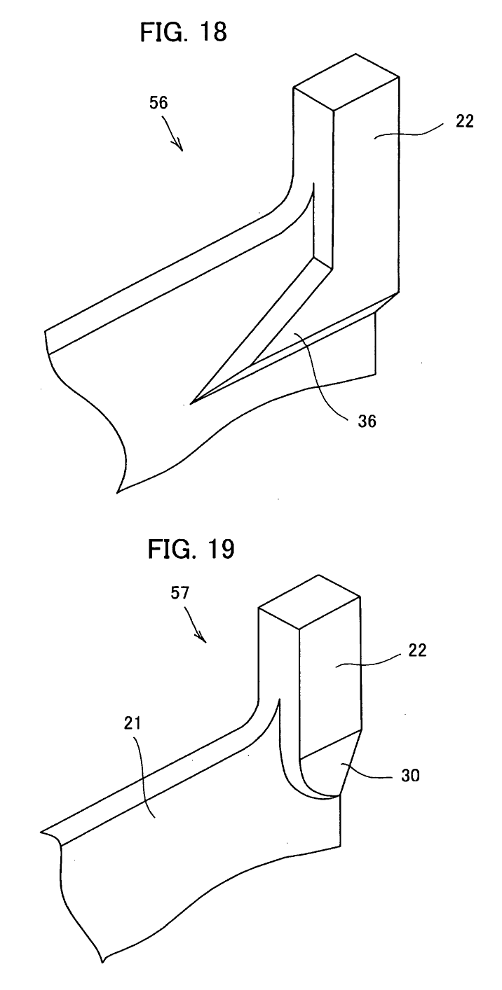

A flat die 56 shown in FIG. 18 has a projecting cavity 22, like that of the flat die 1 shown in FIGS. 1 and 2, with a protruding portion 36. The protruding portion 36 protrudes so as to extend in the width direction “W” from a vicinity of the bottom of the projecting cavity 22 with the length in the resin flowing direction “S” tapering toward the side in the width direction “W”.

A flat die 57 shown in FIG. 19 has a projecting cavity 22, like that of the flat die 2 shown in FIG. 4, with an inclined face 30 formed at the bottom thereof.

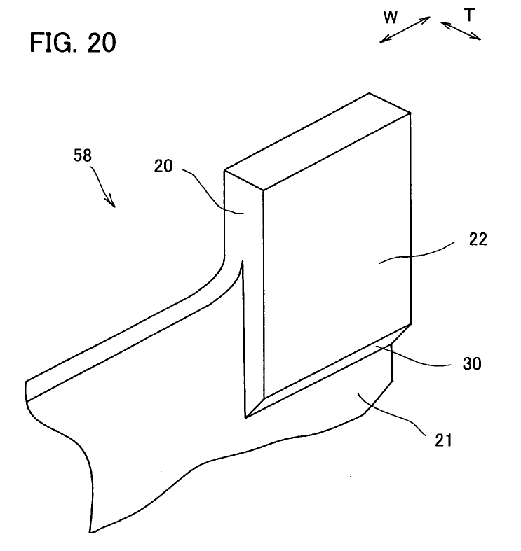

A flat die 58 shown in FIG. 20 has a resin inlet portion 20 and a projecting cavity 22 wider in the width direction “W” than those of the flat die 1 shown in FIGS. 1 and 2 with an inclined face 30 formed at the bottom thereof.

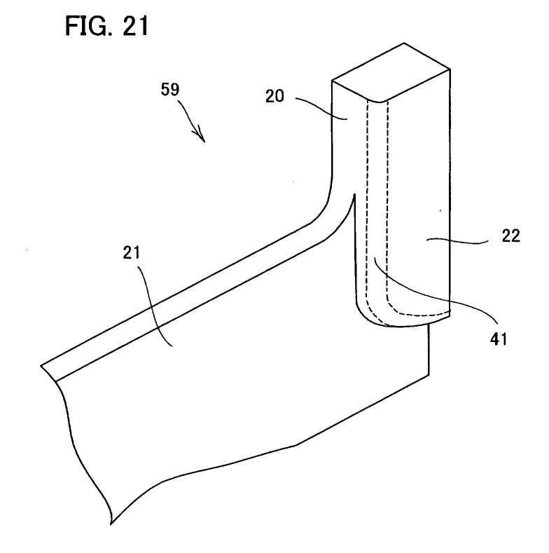

A flat die 59 shown in FIG. 21 has a projecting cavity 22, like that of the flat die 2 shown in FIG. 4, with a rounded (curved) portion 41. Herein, a dotted line in the figure is described for indicating the rounded portion 41 for descriptive purposes.

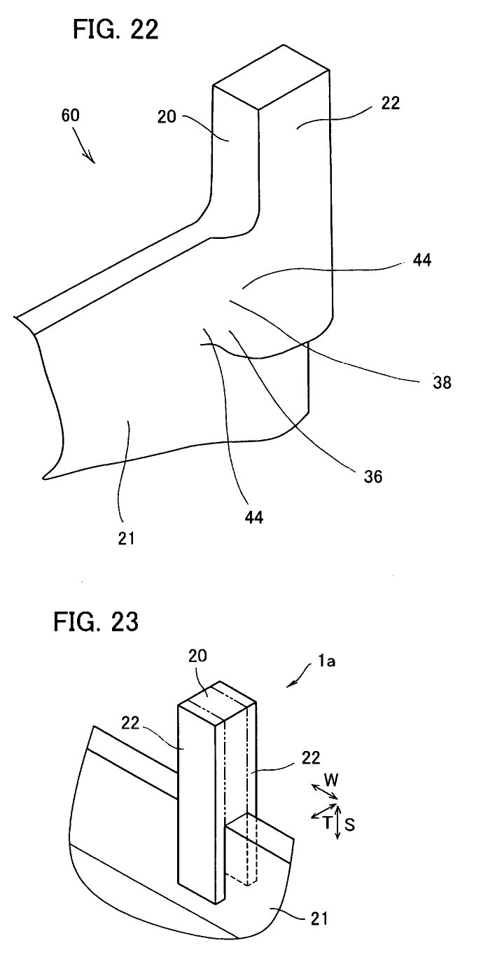

A flat die 60 shown in FIG. 22 has a projecting cavity 22, like that of the flat die 1 shown in FIGS. 1 and 2, with a protruding portion 36. The protruding portion 36 protrudes so as to extend in the width direction “W” from the projecting cavity 22 with the thickness tapering toward the side in the width direction “W” so as to form a curved inclined portion 38. At the end of the protruding portion 36, a rounded portion 44 is formed so as to put the manifold 21 at the same grade level as the projecting cavity 22, thereby providing a smooth transition.

The above-mentioned method for molding describes the laminated sheet 91 composed of two layers of the lower and the higher viscosity resins 90a and 90b, but may be applied to a laminated sheet composed of more than two layers. In this case, a resin to be at the outermost layer (adjacent to the projecting cavity 22) having a viscosity smaller than that of a resin to be at its adjacent layer should be used and laminated to perform molding.

Alternatively, as in a flat die 1a shown in FIG. 23, it is possible to form two projecting cavities 22 projecting toward both sides in the thickness direction “T”. In this case, resins to be at the outermost layers of the both sides having viscosities smaller than that of a resin to be at their adjacent layer should be used and laminated to perform molding.

Further, it is possible to employ flat dies 101, 101a, 102, and 102a described below, each of which has an inclined resin inlet portion 20.

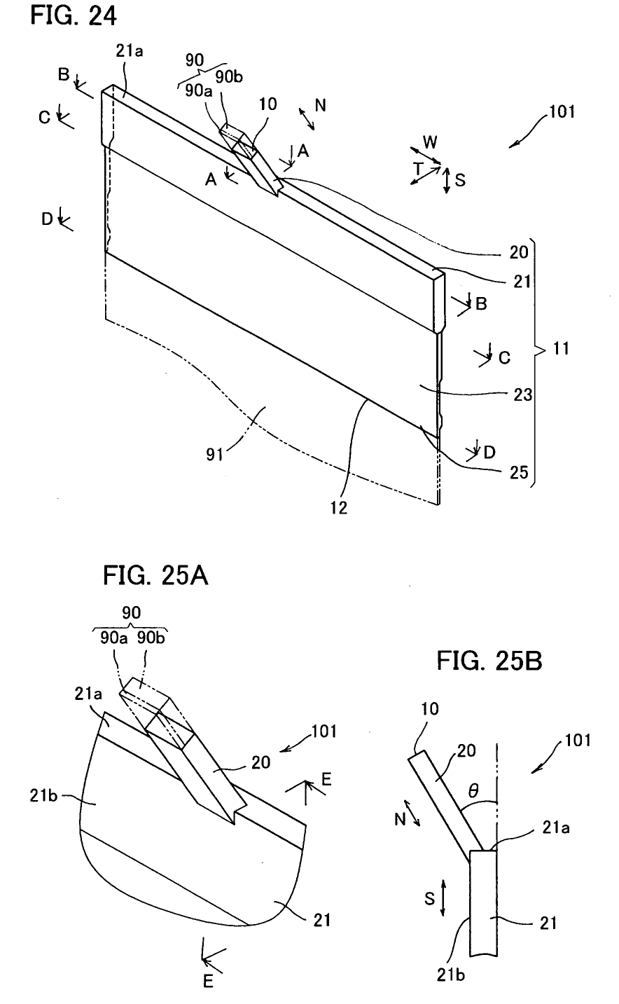

An inner structure of a flat die 101 of a fourth embodiment of the present invention is shown in FIG. 24. The flat die 101 includes a resin inlet 10, an inner cavity 11, and a lip opening 12.

Herein, though not shown, the flat die 101 of the present invention is accompanied with at least two molds and used with these molds, similarly to a normal one.

The resin inlet 10 is connected to a feed block not shown, in which molten resins 90 are laminated. The laminated molten resins 90 are poured into the resin inlet 10, pass through the inner cavity 11, and are extruded and discharged through the lip opening 12 as a laminated sheet 91.

The inner cavity 11 is symmetric and includes a resin inlet portion 20, a manifold 21, a pre-land section 23, and a lip land 25, all parts each having a width in a width direction “W”, a thickness in a thickness direction (a direction perpendicular to the width direction “W”) “T”, and a length in a resin flowing direction (a direction perpendicular to the width direction “W” and the thickness direction “T”) “S”, as well as in the foregoing embodiments.

The resin inlet portion 20 is, as shown in FIGS. 24, 25A, and 25B, a rectangular prism cavity having a longitudinal direction “N”. The resin inlet portion 20 has a proximal end arranged with the resin inlet 10 and a distal end connected to the manifold 21. Thus, the longitudinal direction “N” is a manifold-inflow direction in which the molten resins 90 flow through the resin inlet portion 20 into the manifold 21. The resin inlet portion 20 is connected to the manifold 21 substantially in the center of the width direction “W”.

Since the resin inlet portion 20 is of a rectangular prism shape and the molten resins 90 flow in the longitudinal direction “N”, the resin inlet portion 20 has a substantially same cross sectional shape in any plane perpendicular to the manifold-inflow direction over its full length in the manifold-inflow direction. The cross sectional shape may be completely identical or substantially identical.

The manifold 21 is a cavity of a tabular shape and having a larger width than that of the resin inlet portion 20. The width of the manifold 21 is substantially the same as those of the lip land 25 and the lip opening 12. As described above, the manifold 21 has the resin flowing direction “S” and the thickness direction “T” perpendicular to the width direction “W”, the resin flowing direction “S” being basically a flowing direction of the molten resins 90 in the manifold 21.

The longitudinal direction “N” of the resin inlet portion 20 obliquely crosses (intersects) with the resin flowing direction “S” at an angle θ (theta). The longitudinal direction “N” is perpendicular to the width direction “W” of the manifold 21.

The distal end of the resin inlet portion 20 is connected to the manifold 21, as shown in FIGS. 25A and 25B, so as to be connected to both of a side face 21b and an end face 21a, which is a face at a near side of the resin flowing direction “S” of the manifold 21. Thus, in molding using the flat die 101, as described below, a higher viscosity resin 90b flows into the manifold 21 from the end face 21a, whereas a lower viscosity resin 90a flows into the manifold 21 from the side face 21b.

The molten resins 90 are introduced through the resin inlet portion 20 into the manifold 21. In the manifold 21, the molten resins 90 having been introduced through the resin inlet 10 spread in the width direction “W”, so as to have a flowing direction containing a transverse component in the width direction “W”.

Since the longitudinal direction “N” and the resin flowing direction “S” have the angle θ (theta) therebetween, the molten resins 90 flow from the resin inlet portion 20 to the manifold 21 changing its flowing direction at a bend where the resin inlet portion 20 is connected to the manifold 21 so that the thickness direction “T” (perpendicular to the resin flowing direction “S” and the width direction “W”) is a radial direction in the bend. This oblique crossing allows the molten resin(s) 90 flowing in an outer side at the bend to easily spread in the width direction “W” in the manifold 21 than the molten resin(s) 90 flowing in an inner side at the bend.

The molten resins 90 having passed through the manifold 21 pass through the pre-land section 23 and the lip land 25, thereafter being extruded and discharged through the lip opening 12.

The pre-land section 23 is a region that restricts passage of the resins 90 therethrough more than other parts, thereby adjusting pressure distribution in the width direction “W” so as to stabilize flowing of the molten resins 90 after the pre-land section23.

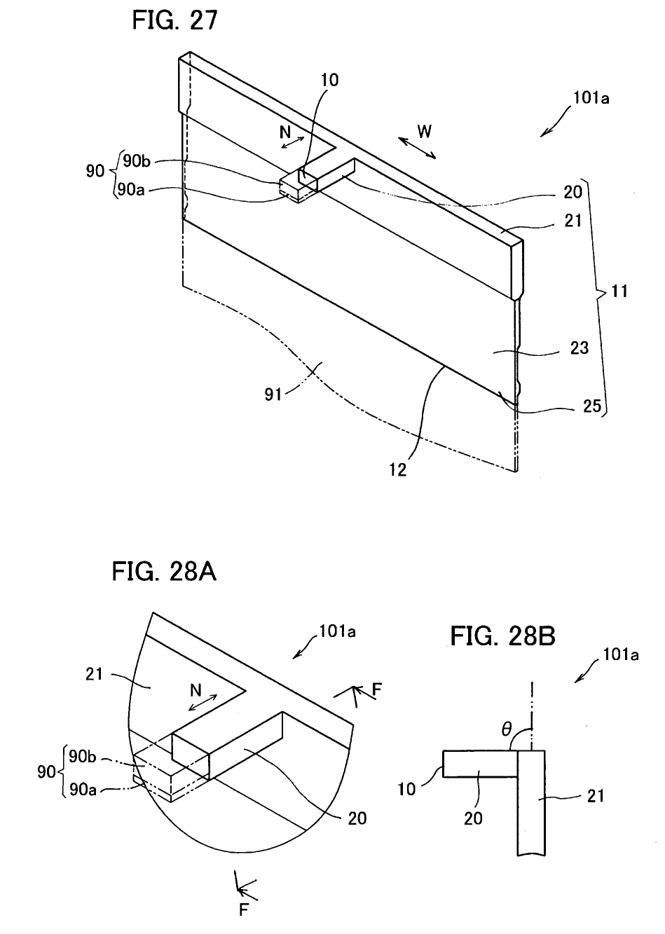

Herein, the angle θ (theta) between the longitudinal direction “N” and the resin flowing direction “S” is not limited to a specific value and may be changed depending on molding conditions such as a viscosity ratio between the lower and the higher viscosity resins 90a and 90b or a thickness of the laminated sheet 91. As in a flat die 101a shown in FIGS. 27, 28A, and 28B, for example, the angle θ (theta) may be 90 degrees.

In the case that the angle θ (theta) is too small, it is difficult to obtain a desired thickness distribution of the laminated sheet 91. In the case that the angle θ (theta) is too large, the resins 90 might flow unstably from the resin inlet portion 20 to the manifold 21. Thus, the angle θ (theta) should be within a range of 10 to 135 degrees and preferably of 45 to 120 degrees.

Now, a method for molding a laminated sheet 91 using the flat die 101 of the fourth embodiment of the present invention will be described below.

The molten resins 90 in a laminated condition are introduced from a feed block not shown through the resin inlet 10 into the inner cavity 11. At this time, as shown in FIG. 24, the molten resins 90 contain a lower viscosity resin 90a and a higher viscosity resin 90b in a laminated condition in the thickness direction “T” (direction perpendicular to the resin flowing direction “S” and the width direction “W”) so that the higher viscosity resin 90b comes to the outer side in the thickness direction “T”.

The lower viscosity resin 90a has a lower viscosity at a molding temperature as compared with the higher viscosity resin 90b. This comparison can be performed by a zero shear viscosity as described above.

Resins used for the flat die 101 of the present invention can be any of the resins described above.

The molten resins 90 having been introduced through the resin inlet 10 in a laminated condition pass through the resin inlet portion 20, entering the manifold 21.

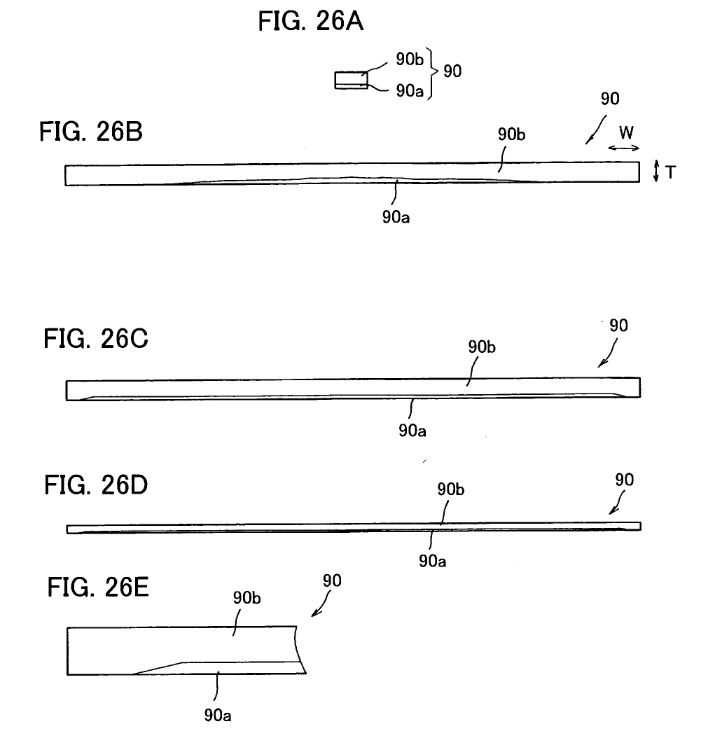

FIG. 26A shows a condition of the molten resins 90 adjacent to the resin inlet portion 20, in the same laminated condition as being introduced through the resin inlet 10.

The molten resins 90 flow further toward the manifold 21. Upon entering the manifold 21, the molten resins 90 flow in an entire area in the width direction “W”. As shown in FIG. 26B, the lower viscosity resin 90a mainly flowing in the inner side in the bend receives repelling force from the higher viscosity resin 90b flowing in the outer side in the bend and enters the manifold 21 proximal to the lip opening 12, thereby increasing flow component in the resin flowing direction “S” more than that in the width direction “W”. As a consequence, the thickness of the lower viscosity resin 90a is relatively reduced at both edges in the width direction “W”.

As the molten resins 90 proceed within the manifold 21 in the resin flowing direction “S”, as shown in FIG. 26C, the lower viscosity resin 90a gradually flows in the width direction “W” because the lower viscosity resin 90a is more flowable than the higher viscosity resin 90b. Then, the molten resins 90 proceed close to the end of the manifold 21 adjacent to the pre-land section 23 (exit of the manifold 21). In this state, as shown in FIG. 26D, the lower viscosity resin 90a does not exist in the entire area of the manifold 21 in the width direction “W” and has both edges in the width direction “W” positioned at inner sides of both sides of the width direction “W” of the manifold 21. The thickness of the lower viscosity resin 90a is substantially uniform except its both edges. The rest part is occupied by the higher viscosity resin 90b.

The molten resins 90 having passed through the manifold 21 flow through the pre-land section 23 and the lip land 25, then being extruded through the lip opening 12. During this flowing, the molten resins 90 do not flow in the width direction “W”, so as to flow maintaining a thickness ratio of the lower and the higher viscosity resins 90a and 90b, becoming into a state as shown in FIGS. 26D and 26E.

As shown in FIG. 26E, the molten resins 90 just after having been discharged through the lip opening 12 shows a lower proportion of the lower viscosity resin 90a to all the resins at each part adjacent to the both edges than that at the other part.

Further, the both edges of the lower viscosity resin 90a in the width direction “W” are inside of both edges of the higher viscosity resin 90b in the width direction “W”. The thickness of the lower viscosity resin 90a is substantially uniform except a part adjacent to the both edges.

In this way, being different from the known art, the lower and the higher viscosity resins 90a and 90b have different ways to spread in the manifold 21. That enables to obtain an intended distribution of the lower viscosity resin 90a in the thickness direction “T” and to adjust a thickness distribution of the lower viscosity resin 90a.

A method for rolling up the laminated sheet 91 is not specifically limited and can employ the above-mentioned method.

In this way, the flat die 101 of the present embodiment is used for laminating the lower and the higher viscosity resins 90a and 90b so that the higher viscosity resin 90b comes to the outer side in the thickness direction “T” (direction perpendicular to the resin flowing direction “S” and the width direction “W”), for supplying the molten resins 90 through the resin inlet 10, and for molding, thereby molding the laminated sheet 91 in such a way that a thickness distribution of the lower viscosity resin 90a in the thickness direction “T” becomes as intended.

The thickness distribution of the lower viscosity resin 90a in the laminated sheet 91 depends on conditions such as viscosities of the lower and the higher viscosity resins 90a and 90b and a flow ratio between the lower and the higher viscosity resins 90a and 90b. However, the thickness distribution is modified as desired by changing of the angle θ (theta).

The laminated sheet 91 is cooled, and molding is completed. According to need, both edges can be cut so that a part of a uniform thickness of the lower and the higher viscosity resins 90a and 90b remains. The cut edges are made of resin containing a high proportion of the higher viscosity resin 90b with quite low proportion of the lower viscosity resin 90a, so that the cut resin is easily recycled as a higher viscosity resin 90b.

Now, a flat die 102 of a fifth embodiment of the present invention will be described below.

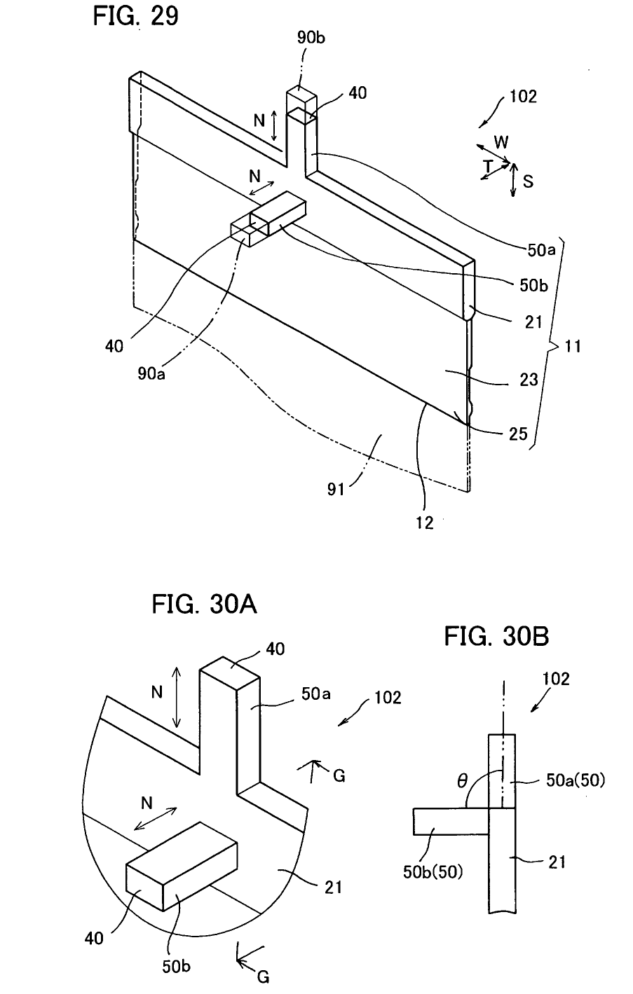

An inner structure of a flat die 102 is shown in FIGS. 29, 30A, and 30B. The flat die 102 includes a plurality of resin inlets 40, an inner cavity 11, and a lip opening 12.

The resin inlets 40 are disposed as many as the number of resins to be used and each are connected to a device such as an extruder not shown. Molten resins 90 are poured into the resin inlets 40 respectively, pass through the inner cavity 11, and are extruded to be discharged through the lip opening 12 as a laminated sheet 91.

The inner cavity 11 is symmetric and includes a plurality of resin inlet portions 50, a manifold 21, a pre-land section 23, and a lip land 25, all parts each having a width in a width direction “W”, a thickness in a thickness direction (a direction perpendicular to the width direction “W”) “T”, and a length in a resin flowing direction (a direction perpendicular to the width direction “W” and the thickness direction “T”) “S”, as well as in the foregoing embodiments.

The resin inlet portions 50 each are a rectangular prism cavity and disposed as many as the resins to be used, similarly to the resin inlets 40. The present embodiment has a first resin inlet portion 50a and a second resin inlet portion 50b. The resin inlet portions 50 each have a proximal end arranged with the resin inlet 40 and a distal end connected to the manifold 21.

The manifold 21 is a cavity having a larger width than that of the resin inlet portions 50. The width of the manifold 21 is substantially the same as those of the lip land 25 and the lip opening 12. As described above, the manifold 21 has the resin flowing direction “S” and the thickness direction “T” perpendicular to the width direction “W”, the resin flowing direction “S” being basically a flowing direction of the molten resins 90 in the manifold 21.

The two resin inlet portions 50 are connected to the manifold 21 in the center of and at a substantially identical position in the width direction “W”, but at different positions in the resin flowing direction “S”. More specifically, the first resin inlet portion 50a is connected to the manifold 21 upstream in the resin flowing direction “S”, whereas the second resin inlet portion 50b is connected thereto downstream in the resin flowing direction “S” and upstream of the lip opening 12.

The resin inlet portions 50 each are a rectangular prism cavity having a longitudinal direction “N”. The longitudinal directions “N” of the first and the second resin inlet portions 50a and 50b are different in direction from each other and form angles θ (theta), which are different from each other, with the resin flowing direction “S”. The angle θ (theta) in the first resin inlet portion 50a is zero degrees and the angle θ (theta) in the second resin inlet portion 50b is 90 degrees.

The molten resins 90 are introduced through the resin inlet portions 50 into the manifold 21. In the manifold 21, the molten resins 90 having been introduced through the resin inlets 40 spread in the width direction “W”, so as to have flowing directions each containing a transverse component in the width direction “W”.

Since the resin inlet portions 50 are connected to the manifold 21 at the different positions in the resin flowing direction “S”, the molten resins 90 flow from the resin inlet portions 50 respectively to the manifold 21 in a different manner in the width direction “W”.

Specifically, since the first resin inlet portion 50a is connected to the manifold 21 upstream in the resin flowing direction “S” of a position where the second resin inlet portion 50b is connected thereto, the molten resin 90b supplied through the first resin inlet portion 50a is exposed to flow pressure of the molten resin 90a supplied through the second resin inlet portion 50b, so as to easily spread in the width direction “W” and spread in a different manner in the width direction “W”.

The molten resins 90 having passed through the manifold 21 pass through the pre-land section 23 and the lip land 25, thereafter being extruded and discharged through the lip opening 12.

The pre-land section 23 is a region that restricts passage of the resins 90 therethrough more than other parts, thereby adjusting pressure distribution in the width direction “W” so as to stabilize flowing of the molten resins 90 after the pre-land section23.

Herein, the angles θ (theta) between the longitudinal directions “N” and the resin flowing direction “S” in the first and the second resin inlet portions 50a and 50b are not limited to specific values and may be values determined by a positional relationship between the first and the second resin inlet portions 50a and 50b that would not interfere each other, that is, would not cross each other. Further, the positional relationship may be changed depending on molding conditions such as a viscosity ratio between a lower viscosity resin 90a and a higher viscosity resin 90b or a thickness of the laminated sheet 91.

Now, a method for molding a laminated sheet 91 using the flat die 102 of the fifth embodiment of the present invention will be described below.

The molten resins 90 are introduced from an extruder not shown through the resin inlets 40 into the inner cavity 11. At this time, as shown in FIG. 29, a higher viscosity resin 90b is introduced into the first resin inlet portion 50a and a lower viscosity resin 90a is introduced into the second resin inlet portion 50b.

Herein, viscosities of the lower and the higher viscosity resins 90a and 90b is compared by a zero shear viscosity as described above. Further, resins used for the flat die 102 of the present invention can also use the same kinds of resins described above.

The molten resins 90 having been introduced through the resin inlets 40 respectively pass through the resin inlet portions 50, entering the manifold 21.

Upon entering the manifold 21, the molten resins 90 flow in an entire area in the width direction “W”, but each can flow in a different manner in the width direction “W” because of the different positions where the resin inlet portions 50 are connected to the manifold 21. More specifically, the higher viscosity resin 90b flowing from the first resin inlet portion 50a flows into the manifold 21 from an upper stream in the resin flowing direction “S” of the lower viscosity resin 90a flowing from the second resin inlet portion 50b, so as to spread wider in the width direction “W”. That relatively reduces the thickness of the lower viscosity resin 90a at both edges in the width direction “W” and enables adjustment of a thickness distribution of the lower viscosity resin 90a.

Then, similarly to the flat die 101 of the above-mentioned fourth embodiment, the lower and the higher viscosity resins 90a and 90b are extruded through the lip opening 12, and whereby the laminated sheet 91 is molded. Herein, the thickness distribution within the manifold 21 in molding or the thickness distribution of the laminated sheet 91 is the same as those in molding by the flat die 101 of the fourth embodiment. Further, the same can be said to a method for rolling up the laminated sheet 91.

In this way, the flat die 102 of the present embodiment is used for introducing the higher viscosity resin 90b into the first resin inlet portion 50a and the lower viscosity resin 90a into the second resin inlet portion 50b and for molding, thereby molding the laminated sheet 91 in such a way that a thickness distribution of the lower viscosity resin 90a in the thickness direction “T” becomes as intended.

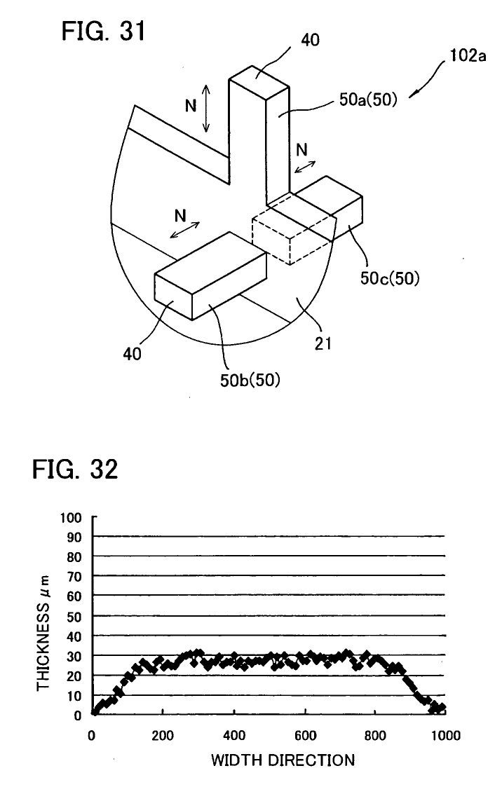

It is also possible to dispose the resin inlet portions 50 at more than two positions as in a flat die 102a shown in FIG. 31. The flat die 102a has three resin inlet portions 50a, 50b, and 50c. Molding is performed by supplying a higher viscosity resin 90b having a high viscosity to the resin inlet portion 50a connected to an upper stream in the resin flowing direction “S” and lower viscosity resins 90a having a low viscosity to the other resin inlet portions 50b and 50c.

### EXAMPLES

By a method described below, a laminated sheet 91 was molded so as to confirm a thickness distribution of the resulting molded article.

### Example 1

The flat die 1 of the first embodiment was used. In the flat die 1, the projecting cavity 22 had the thickness “a1” of 5 mm, the width “a2” of 50 mm, and the length “a4” (length of the lower portion 35) of 35 mm. The manifold 21 had a width “W” of 1,000 mm. The resin inlet portion 20 had the thickness in the thickness direction “T” of 25 mm and the manifold 21 had that of 20 mm. In molding, a feed block had a temperature of 170 degrees Centigrade and the flat die 1 had a temperature of 190 degrees Centigrade.

Styrene-ethylene butylenes block copolymer (a trade name “KRATON G-1657” by Kraton Polymers LLC) was used as the lower viscosity resin 90a. Low-density polyethylene (LDPE, a trade name “Mirason 12” by Mitsui Chemicals, Inc.) was used as the higher viscosity resin 90b.

Viscosities of the lower and the higher viscosity resins 90a and 90b were measured by a mechanical spectrometer (a trade name “RMS800” by Rheometric Scientific F.E. LTD.). A measurement condition was a shear speed 0.1 (1/s). As a result, styrene-ethylene butylenes block copolymer, which was the lower viscosity resin 90a, showed 200 Pa·s and LDPE, which was the higher viscosity resin 90b, showed 5,000 Pa·s.

The lower viscosity and the higher viscosity resins 90a and 90b described above were supplied to the feed block in molten state, and then supplied to the flat die 1 in a laminated condition. When supplied to the flat die 1, the lower viscosity resin 90a was positioned proximal to the projecting cavity 22. The supply of the lower viscosity resin 90a was 10 kg/hour and that of the higher viscosity resin 90b was 50 kg/hour.

### Example 2

Molding was carried out under the same conditions with the Example 1, except the supply of the lower viscosity resin 90a, which was 20 kg/hour.

### Example 3

Molding was carried out under the same conditions with the Example 1, except changing of the lower and the higher viscosity resins 90a and 90b and changing of temperatures of the feed block and the flat die 1 into 250 degrees Centigrade.

The lower viscosity resin 90a used in the Example 3 was polybutylene terephthalate (a trade name “Julanex 700FP” by Polyplastics Co., Ltd.), whose viscosity was 600 Pa·s by the above-mentioned method of measurement.

The higher viscosity resin 90b was ethylene-ethyl acrylate copolymer (EEA, a trade name “EVAFLEX A-710 by Du Pont-Mitsui Polychemicals Co., Ltd.), whose viscosity was 29,000 Pa·s by the above-mentioned method of measurement.

### Comparative Example 1

Molding was carried out under the same conditions with the Example 1 except the use of another type of flat die. A flat die used in the Comparative Example 1 was like the flat die 1 used in the Example 1, but without the projecting cavity 22.

### Comparative Example 2

Molding was carried out under the same conditions with the Example 2 except the use of another type of flat die. A flat die used in the Comparative Example 2 was like the flat die 1 used in the Example 1, but without the projecting cavity 22.

### Comparative Example 3

Molding was carried out under the same conditions with the Example 3 except the use of another type of flat die. A flat die used in the Comparative Example 3 was like the flat die 1 used in the Example 1, but without the projecting cavity 22.

Variation of a thickness of the lower viscosity resin 90a in each of the Examples 1 to 3 and the Comparative Examples 1 to 3 as described above was tested. Herein, the variation denotes a percentage of difference between a part having the smallest thickness and a part having the largest thickness to the average thickness. The result showed 10% to the average thickness in the Examples 1 and 3 and 7% thereto in the Example 2, whereas 25% thereto in the Comparative Example 1, 35% thereto in the Comparative Example 2, and 30% thereto in the Comparative Example 3. The Examples 1 to 3 produced excellent results, but the Comparative Examples 1 to 3 each produced a big difference.

Further, in each case, a laminated condition of the edges of the laminated sheet 91 in the width direction “W” was tested, showing that the Examples 1 to 3 produced good results without defective lamination and avoided production of a monolayer region composed of the lower viscosity resin 90a (without the high viscosity resin 90b). However, the Comparative Examples 1 to 3 resulted in defective lamination and production of a monolayer region composed of the lower viscosity resin 90a.

More specifically, the monolayer region composed of the lower viscosity resin 90a was 20 mm from the edge in the Comparative Example 1, mm therefrom in the Comparative Example 2, and 15 mm therefrom in the Comparative Example 3.

Aside from the above-mentioned tests, a laminated sheet 91 was molded by the following method and a thickness distribution of the resulting molded article was tested so as to confirm influence by the angle θ (theta) of the resin inlet portion 20.

### Example 4

The flat die 101a shown in FIG. 27 was used for molding a laminated sheet 91 in Example 4. Herein, the angle θ (theta) was 90 degrees and the width of the manifold 21 in the width direction “W” was 1,000 mm. The resin inlet portion 20 had the thickness in the thickness direction “T” of 20 mm and the width in the width direction “W” of 50 mm. The molten resins 90 composed of the lower and the higher viscosity resins 90a and 90b having been laminated in a feed block not shown were introduced through the resin inlet 10 into the inner cavity 11. At this time, the molten resins 90 were laminated so that the higher viscosity resin 90b came to the outer side in the bend. In molding, the feed block had a temperature of 170 degrees Centigrade and the flat die 101a had a temperature of 190 degrees Centigrade.

Herein, the lower and the higher viscosity resins 90a and 90b used for the laminated sheet 91 in the Example 4 and the supply of the resins were the same as those in the Example 1.

### Comparative Example 4

Molding was carried out under the same conditions with the Example 4 except the use of another type of flat die. A flat die used in the Comparative Example 4, unlike the flat die 101a used in the Example 4, was the same one as the Comparative Example 1, wherein the angle θ (theta) was zero degrees, that is, the resin inlet portion 20 did not incline.

As to the Example 4 and the Comparative Example 4 as described above, variation of a thickness of the lower viscosity resin 90a within a range of 200 mm inside from the edge in the width direction “W” was tested. Herein, the variation denotes a percentage of difference between a part having the smallest thickness and a part having the largest thickness to the average thickness. The result showed 20% to the average thickness in the Example 4, whereas 40% thereto in the Comparative Example 4. The Example 4 produced an excellent result, but the Comparative Example 4 produced a big difference. Further, the Comparative Example 4 contained a higher proportion of the lower viscosity resin 90a adjacent to the edges and resulted in defective lamination at the edges with a monolayer range of the lower viscosity resin 90a of 18 mm in the width direction “W”.

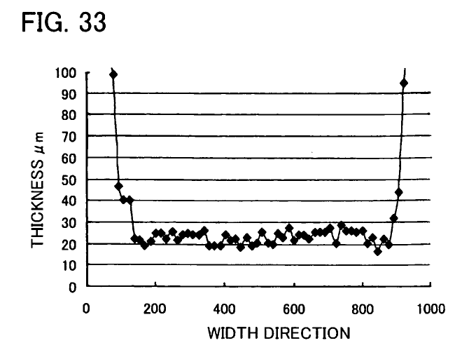

Further, a thickness distribution of the lower viscosity resin 90a in each of the Example 4 and the Comparative Example 4 was tested. FIG. 32 is a graph showing the thickness distribution of the lower viscosity resin 90a in the Example 4. FIG. 33 is a graph showing the thickness distribution of the lower viscosity resin 90a in the Comparative Example 4. The results showed that the Example 4 contained the lower viscosity resin 90a adjacent to the edges thinner as compared with the entire sheet. In contrast, the Comparative Example 4 contained the lower viscosity resin 90a adjacent to the edges thicker as compared therewith.

Herein, the method for molding of the present invention illustrates the laminated sheet 91 having two layers composed of the lower and the higher viscosity resins 90a and 90b, but can be applied to one having more than two layers.

An article produced by the flat die of the present invention is not limited to the laminated sheet 91, but may be any resin in a laminated condition and can be a laminated film thinner than the laminated sheet 91.

1-16. (canceled)

17. A flat die for use in molding at least two resins, comprising:
a resin inlet portion for introducing molten resins therethrough;
a manifold connected to the resin inlet portion; and
a lip opening for discharging the resins therethrough,
wherein the manifold comprises a cavity defining a width direction, a thickness direction, and a resin flowing direction, the directions being perpendicular to one another;
wherein the manifold has a larger width in the width direction as compared with the resin inlet portion;
wherein molten resins supplied to the die through the resin inlet portion are to enter the manifold and to flow so as to spread in the width direction in the manifold, then being discharged through the lip opening; and
wherein, when resins of different kinds flow in the manifold in a laminated condition in which each resin forms a layer in the thickness direction, the die allows each resin to be introduced into the manifold so that one layer of resin spreads in the width direction in a different way from an adjoining layer of resin.

18. A flat die for use in molding resin, comprising:
a resin inlet portion for introducing at least one molten resin therethrough;
a manifold connected to the resin inlet portion and defining a width direction and a thickness direction perpendicular to the width direction;
a projecting cavity formed adjacent to the resin inlet portion and to part of the manifold where the manifold is connected to the resin inlet portion so that the projecting cavity projects in the thickness direction as compared with the manifold; and
a lip opening for discharging the resin therethrough,
wherein the manifold has a larger width in the width direction as compared with the resin inlet portion; and
wherein molten resin supplied to the die through the resin inlet portion and the projecting cavity is to enter the manifold and to flow so as to spread in the width direction in the manifold, then being discharged through the lip opening.

19. The flat die as defined in claim 18,
wherein the projecting cavity comprises a first part adjacent to the manifold and a second part adjacent to the resin inlet portion, the first part having a larger width in the width direction than that of the second part.

20. The flat die as defined in claim 18,
wherein the projecting cavity has an inclined face adjacent to a distal end thereof, the face being located proximal to the lip opening and tapering toward the lip opening.

21. The flat die as defined in claim 18,
wherein the projecting cavity shows a projection view in the thickness direction with no angle formed proximal to the lip opening.

22. A method for manufacturing a laminated resin film and/or sheet using the flat die as defined in claim 18, comprising the steps of:
laminating a plurality of molten resins in the thickness direction, the resins including a lower viscosity resin and a higher viscosity resin, the lower viscosity resin having a lower viscosity at a molding temperature than that of the higher viscosity resin;
introducing the resins through the resin inlet portion and the projecting cavity into the manifold; and
discharging through the lip opening the resins having passed through the manifold,
so that the lower viscosity resin is molded so as to be located proximal to the projecting cavity.

23. The method as defined in claim 22,
wherein the laminated resin film and/or sheet just after being discharged through the lip opening shows a lower proportion of the lower viscosity resin to all the resins at each part adjacent to both edges than that at the other part or has no lower viscosity resin adjacent to the both edges.

24. The method as defined in claim 22,
using a zero shear viscosity so as to compare viscosities at a molding temperature.

25. A flat die for use in molding resin, comprising:
a resin inlet portion for introducing at least one molten resin therethrough;
a manifold connected to the resin inlet portion; and
a lip opening for discharging the resin therethrough,
wherein the manifold comprises a cavity defining a width direction, a thickness direction, and a resin flowing direction, the directions being perpendicular to one another,
wherein the manifold has a larger width in the width direction as compared with the resin inlet portion; and
wherein molten resin supplied to the die through the resin inlet portion is to flow into the manifold in a manifold-inflow direction crosswise to the resin flowing direction;
so that the supplied resin enters the manifold and flows so as to spread in the width direction in the manifold, then being discharged through the lip opening.

26. The flat die as defined in claim 25,
wherein the resin inlet portion is a columnar cavity having a longitudinal direction substantially identical with the manifold-inflow direction.

27. The flat die as defined in claim 25,
wherein the resin inlet portion has a substantially same cross sectional shape in any plane perpendicular to the manifold-inflow direction over its full length in the manifold-inflow direction.

28. A flat die for use in molding at least two molten resins, comprising:
a plurality of resin inlet portions for introducing molten resins therethrough;
a manifold connected to the resin inlet portions; and
a lip opening for discharging the resins therethrough,
wherein the manifold comprises a cavity defining a width direction, a thickness direction, and a resin flowing direction, the directions being perpendicular to one another;
wherein the manifold has a larger width in the width direction as compared with the resin inlet portions; and
wherein the resin inlet portions are connected to the manifold at an identical position in the width direction and at different positions in the resin flowing direction,
so that molten resins supplied to the die through the resin inlet portions enter the manifold and flow so as to spread in the manifold in the width direction, then being discharged through the lip opening.

29. A method for manufacturing a laminated resin film and/or sheet using the flat die as defined in claim 25, comprising the steps of:
laminating a plurality of resins in the thickness direction so that a resin of a low viscosity at a molding temperature is located proximal to the lip opening;
introducing the resins through the resin inlet portion; and
molding the resins.

30. A method for manufacturing a laminated resin film and/or sheet using the flat die as defined in claim 28, comprising the steps of:
introducing different resins into the resin inlet portions respectively; and
molding the resins,
wherein a molten resin of a low viscosity at a molding temperature is introduced through a resin inlet portion connected to the manifold proximal to the lip opening.

31. The method as defined in claim 29,
wherein the laminated resin film and/or sheet just after being discharged through the lip opening shows a lower proportion of the lower viscosity resin to all the resins at each part adjacent to both edges than that at the other part or has no lower viscosity resin adjacent to the both edges.

32. The method as defined in claim 29,
using a zero shear viscosity so as to compare viscosities at a molding temperature.

33. The method as defined in claim 30,
wherein the laminated resin film and/or sheet just after being discharged through the lip opening shows a lower proportion of the lower viscosity resin to all the resins at each part adjacent to both edges than that at the other part or has no lower viscosity resin adjacent to the both edges.

34. The method as defined in claim 30,
using a zero shear viscosity so as to compare viscosities at a molding temperature.
